(19) United States
(12) Patent Application Publication
(10) Pub. No.: US 2010/0046825 A1
(43) Pub. Date: Feb. 25, 2010

(54) AUTHENTICATION AND ANTICOUNTERFEITING METHODS AND DEVICES

(75) Inventor: Robert C. Haushalter, Los Gatos, CA (US)

Correspondence Address: DUANE MORRIS LLP - Princeton, PO BOX 5203, PRINCETON, NJ, 08543-5203, US

(73) Assignee: Parallel Synthesis Technologies, Inc., Santa Clara, CA (US)

(21) Appl. No.: 12/278,822

(22) PCT Filed: Feb. 12, 2007
(86) PCT No.: PCT/US07/62001

§ 371 Date: Oct. 22, 2009

Related U.S. Application Data
(60) Provisional application No. 60/772,181, filed on Feb. 10, 2006.

(51) Int. Cl. G06K 9/00

(52) U.S. Cl. 382/141

(57) ABSTRACT

Methods and devices for marking objects include the use of a dimensionally hierarchical series of submicron sized features to emboss, mold, and/or print markings into objects. The markings may include security features, codes, numbers, symbols, signs and any combinations thereof. The markings may be used for identification, authentication or attribution of the item.

### RELATED APPLICATIONS

This application claims the benefit of U.S. Provisional Application No. 60/772,181 filed on Feb. 10, 2006, the entire disclosure of which is incorporated herein by reference.

### FIELD OF THE INVENTION

This invention relates to methods and devices for authentication and anticounterfeiting.

### BACKGROUND OF INVENTION

The counterfeiting of consumer goods, spare parts, pharmaceuticals and many other items is a very large and growing problem at all levels of society from individuals and families to entire countries. Counterfeiting and detection of the counterfeits is an age old problem and, like encryption and decryption, will always continue to evolve along with new counterfeiting and detection methods

An ideal anticounterfeiting technology should be very easy to use, inexpensive, impossible to replicate or reverse engineer and give complete security protection by virtue of its inability to be deciphered. Such technology is a reality for digital data content and is known as the public key-private key encryption technology, such as that used commercially, for example, by PGP, Inc.

A corresponding level of protection for physical objects is much less well developed. Therefore, authentication and anticounterfeiting technology is needed for physical objects.

### SUMMARY

In one embodiment, a method for identifying, authenticating, and/or attributing information to an object comprises reading a marking formed in or on a surface of an object, comparing the marking to a marking feature of a stamp or mold that would have been used to legitimately mark the object, the marking feature of the stamp or mold including at least one identifying defect that is unique to the stamp or mold, and determining whether the marking in or on the surface of the object includes a corresponding feature including the at least one identifying defect to identify, authenticate, and/or attribute information to the object.

In another embodiment, a method for identifying, authenticating, and/or attributing information to an object comprises forming a stamp or mold including a marking feature, the marking feature including at least one identifying defect that is unique to the stamp or mold, and marking the object with the stamp or mold. The marking formed in or on the surface of the object can be used to identify, authenticate, and/or attribute information to the object.

In another embodiment, a device for identifying, authenticating, and/or attributing information to an object comprises a surface including a marking feature. The marking feature of the device includes at least one identifying defect that is unique to the device. In operation, the device forms a marking in or on the surface of the object which may be used to identify, authenticate, and/or attribute information to the object.

In another embodiment, the information stamped onto the object constitutes the input or output of a digital encryption algorithm much like those in current use to encrypt email or other digital media. For instance one popular type of encryption algorithm is referred to as Public Key-Private Key (PK-PK) encryption. Stamping an object with a PK-PK code immediately allows the recognition of the code as authentic. In other words, any attempt to create a new code will be immediately recognized as counterfeit

### BRIEF DESCRIPTION OF DRAWINGS

FIGS. 1A-1D collectively illustrate an embodiment of a stamp of the invention.

FIGS. 2A-2C illustrate one embodiment of a method for fabricating stamps, molds, and/or objects according to the principles of the invention.

FIGS. 3A-3C illustrate another embodiment of a method for fabricating the stamps, molds, and/or objects according to the principles of the invention.

FIGS. 4A-4C illustrate yet another embodiment of a method for fabricating the stamps and/or objects according to the principles of the invention.

FIG. 5 illustrates an embodiment of a polymer wafer including a plurality polymer stamps and/or objects made using the electroform mold process described above.

### DETAILED DESCRIPTION OF THE INVENTION

Methods and devices are disclosed for marking objects and using the markings for object identification, authentication, attribution, combinations thereof, and other related or similar functions. Methods are also disclosed for making the aforementioned marking devices.

In one embodiment, the marking device comprises a stamp including a series of three-dimensional features. In some embodiments, the three-dimensional features may be formed in a dimensional hierarchy. In other embodiments, the three-dimensional features need not be formed in a dimensional hierarchy. In any case, the three-dimensional features of the stamp may be used, in one embodiment, to emboss markings into a surface of an object, for example an embossable thin film or pharmaceutical tablet or pill, without the use of conventional labels or the addition of any type of extrinsic foreign, extraneous or adventitious chemical or material. Appropriately, this embodiment of the invention is referred to herein as “Label Free Anticounterfeiting Technology” (LFAT) because no labeling material is applied to the object to be marked. LFAT may be used to mark other embossable materials including, but not limited to paper, films of organic polymers, cellulose, metals, metal films, inorganic polymers such as silicones, sol-gel derived films and embossable ceramics.

In an alternative embodiment, the features of the stamp may be used to print markings onto a surface of an object using, for example, contact printing techniques. In such an embodiment, the markings printed by the stamp may be made of any type of extrinsic foreign, extraneous or adventitious chemical or material, such as ink. For example, the feature defining surface of the stamp may be dipped into a printing ink and then brought into contact with a surface of the object to be marked.

In one preferred embodiment, materials to optically encode the object to be protected are printed onto the object. Materials suitable for optical encoding include, without limitation, any type of colored pigment, organic dye, upconverting or downconverting phosphor materials or quantum dots. Codes based on the number, intensity, width or temporal length of the emitted or absorbed electromagnetic radiation may be applied.

The embossed or printed markings created by the features of the stamp may include, without limitation, security features, codes, numbers, symbols, signs, digital watermarks, arbitrary shapes, and combinations thereof. The embossed or printed markings may be read to identify, authenticate, and/or ascribe something to the object. In some applications, a relational database is used to relate the object's markings to identifying, authentication, attribution information, e.g., data regarding the features of the stamp that produced the markings on the object.

The dimensional hierarchy of the stamp features provides increasing levels of security with increasing feature size diminution in terms of the ability to read and/or create the security features. In one embodiment, the dimensional hierarchy of the stamp features may cover a range of feature sizes from about 0.5 mm to about 50 nanometers.

In one preferred embodiment, the stamp may be fabricated with features that form a Public Key-Private Key type of encryption code. Public Key-Private Key encryption is a well known type of encryption method that uses an encryption algorithm that is based on the factoring of large prime numbers. The stamp is then used to encode a pharmaceutical tablet, pill, or other preparation with the Public Key-Private Key type of encryption code by embossing a surface of the tablet or pill with the code, thus adding a layer of impossible-to decrypt digital encryption on top of the physical protection afforded by the defect-derived physical uniqueness. The characters created by the stamp actually form a digitally encrypted code. This technique relies on a so-called Public Key-Private Key encryption. Therefore, not only can each individual stamp be rendered unable to be replicated via the microfabrication techniques discussed above but by simply reading the stamped ˜200 digit alphanumeric code with a private digital encryption algorithm one can instantly verify the code itself as real. Therefore no new alphanumeric codes can ever be generated. The Public. Key-Private Key type encryption algorithm has proven unbreakable in decades of use.

The stamp maybe made of a suitably rigid material including, without limitation, semiconductor, ceramic, glass, or suitably rigid polymeric materials. In one embodiment, the stamp may be made of silicon. The silicon stamp may be microfabricated from one or more silicon wafers or substrates using conventional silicon micromachining techniques and methods. In another embodiment, the stamp may be made from one or more electroforms where the one or more electroforms have been formed from one or more microfabricated silicon molds by conventional electroplating or electroforming techniques. In yet another embodiment, the stamp may be made of a polymer which has replicated the features of a silicon, metal, or molds made from other suitably rigid materials. The plastic stamp may be formed in a mold using conventional plastic forming techniques. The mold used for forming the plastic stamp may be one or more electroforms which have been fabricated using conventional electroforming techniques and methods or could be a silicon mold etched as described above.

Regardless of the stamp material and/or the stamp fabrication technique, each stamp includes unique identifying traits or “defects” associated with certain features of the stamp that are randomly and naturally generated by the fabrication process. The stamp is protected is by its own unique physical structure. The information content that is preventing replication is the unique arrangement of thousands of random and unavoidable defects which are scattered over billions of possible locations on the stamp rendering a unique, random and totally irreproducible pattern associated with each stamp. In a 2 mm×2 mm stamp it is estimated, based on previous experiments in examining the number of defects generated as a function of the area of the sample exposed and the lithography resolution, that defects will be generated on the order of one defect every 50 nm. The question then becomes how many 50 nm defects can be placed on a given size substrate and how many unique patterns can be formed by placement of additional defects. For example, if a defect is 50 nm and the substrate is 2 mm×2 mm, then the first visualized defect can reside at any one of the ˜2×10¹¹ sites on the 2 mm×2 mm stamp. The odds of placing a second defect at a given arbitrary location is only one out (2×10¹¹−1) so it is clear that by the time one generates even 100 randomly located defects on the stamp (an exceedingly low defect level) the chances of the defect pattern (i.e. stamp) being identical to another is infinitesimally small.

It is important to note that the final part has defects accumulated from (a) the photomask (b) the photoresist (c) the photoresist development (d) the silicon etching (e) the electroforming operation to prepare the stamp and (f) the stamping operation itself thereby absolutely ruling out any chance of successful replication of the myriad defect generation sources.

It should be apparent to those skilled in the art that the numerous random defects can be generated in ways other than photolithography. For example, a metal surface could be prepared by “grit-blasting” the surface (ie. bombarding the surface with numerous sub-micron particles in a fast moving stream of gas or liquid). The pattern generated on the surface would consist of the pattern generated from thousands or millions or fine particles denting the surface as they impinge on it. In another embodiment, the huge number of random structures may be generated from the inclusion of numerous small particles in a coating or film which can be sprayed or other wise applied to the object to be authenticated. In an exactly analogous fashion to the defects discussed above, the added particles (thousands or millions) can occupy billions of potential locations. By photographing or otherwise recording the locations of the particles a unique pattern has been created and recognized.

Because each randomly and naturally occurring defect has it own identifying size, shape location within the feature, and proximity to other defects, the probability that another stamp will have a defect with the exact same size, shape, location, and proximity to other defects is virtually impossible. Accordingly, each stamp is virtually impossible to exactly replicate or reverse engineer. When a stamp is used to mark the object, its identifying traits or defects will also emboss the surface of the object and may be read or otherwise used to identify, authenticate, and/or ascribe something to the object.

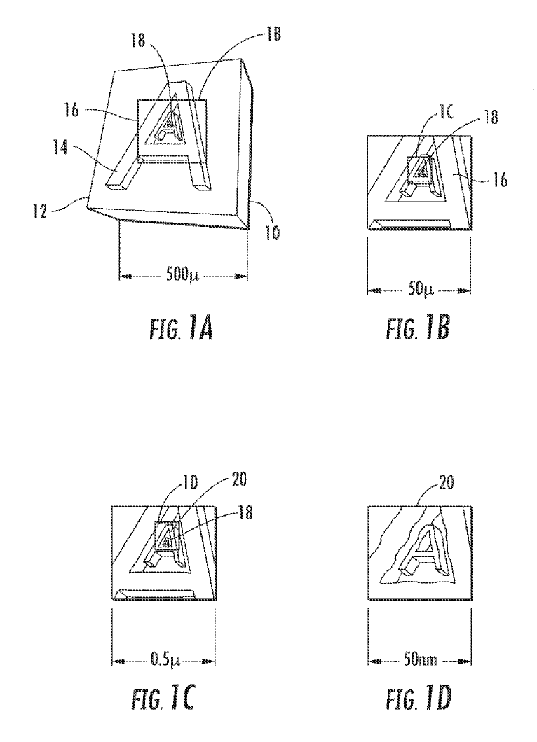

FIGS. 1A-1D collectively illustrate an embodiment of a stamp 10 microfabricated of silicon that includes a series of four (4), 3-dimensional A-shape features 14, 16, 18, 20 arranged in a dimensional hierarchy, formed in an embossing surface 12 of the stamp 10. As can be seen, the four, 3-dimensional A-shape features decrease in size from FIG. 1A to FIG. 1D. FIG. 1A is a perspective view showing the entire stamp embossing surface 12 of the stamp 10 and A-shape features 14, 16, and 18 (A-shape feature 20 is not visible). FIG. 1B, is an enlarged view of the bounded region 1B shown in FIG. 1A depicting A-shape features 16 and 18. FIG. 1C is an enlarged view of the bounded region 1C shown in FIG. 1B depicting A-shape features 18 and 20. FIG. 1D is an enlarged view of the bounded region 1D shown in FIG. 1C depicting A-shape feature 20.

The accuracy of the A-shape feature 20 shown in FIG. 1D (the smallest feature of the series) is less than perfect because the lithography, exposure and development techniques have been performed below their optimum resolution limits. Consequently, the smallest A-shape feature 20 of the stamp 10 created in the silicon wafer Includes it own unique identifying traits or defects (e.g., bumps and dips in the line features).

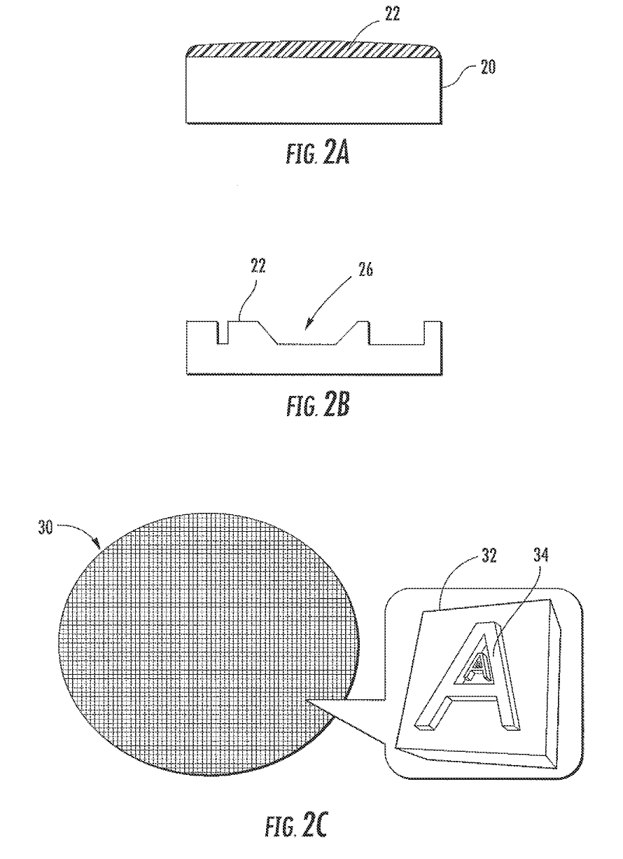

FIGS. 2A-2C illustrate one embodiment of a method for fabricating the stamps of the invention. In the method, a positive master mold made of silicon (silicon master) is fabricated using conventional silicon microfabrication techniques. First, a feature pattern for a stamp, e.g., a series of 3-dimensional features arranged in a dimensional hierarchy, may be created in a CAD drawing program. The CAD drawing program is used for controlling an electron beam that writes the feature pattern (which in one embodiment, may range in size from 0.5 mm to about 50 nm) in a layer of photoresist 24 deposited on a surface 22 of a silicon wafer 20 (e.g. a 150 mm wafer), as shown in FIG. 2A. Alternatively, the CAD drawing program may be used for preparing a photomask of the feature pattern which is suitable for carrying out UV or X-ray lithography on the photoresist layer 24.

After development, which removes the areas irradiated by the electron beam, the silicon wafer 20 is etched to remove the silicon exposed during the previously described lithography, exposure and development steps. In one embodiment, etching may be performed using a DRIE process. Depending on the sequence of masking steps employed, at least one depth is etched into the wafer 20 to define a 3-dimensional relief pattern 26 in the surface 22 of the wafer 20, as shown in FIG. 2B.

By controlling the type, number and size of a series of sacrificial layers used to protect the silicon during the etching process it is possible to etch the pattern into the silicon wafer at more than one etch depth. For example, by etching the sample for time X, followed by removing a sacrificial etch stop protection layer and continuing to etch for time X again, gives a surface with two depths corresponding to the depths obtained from the two different etch times.

Care must be exercised in the feature design so as not to prepare feature structures having an aspect ratio in the silicon master or subsequent electroformed negative mold, that become too tall and thin to be of any practical use.

After etching, the unexposed photoresist is removed from the silicon wafer, as depicted in FIG. 2B. The silicon wafer 20 now referred to as a silicon master 30, may then be subjected to a wet oxidation procedure to produce a thin film of SiO₂ (not shown) on all the surfaces of the wafer 20. At this point the silicon master 30, as shown in FIG. 2C, includes a plurality of stamp and/or object forming molds 32 each of which has the earlier described 3-dimensional series features 34 arranged in a dimensional hierarchy. The series of hierarchical features 34 of each stamp and/or object forming mold 32 has its own unique identifying traits or defects.

To fabricate a stamp that is virtually impossible to be fabricated again or replicated, advantage is taken of the resolution limits of the photolithography or electron beam exposure and the subsequent etching and development steps. Using the writing and developing technology slightly below its resolution limits allows the preparation of recognizable features but the features and surrounding areas are replete with some number of naturally occurring and naturally generated defects which manifest themselves as a positive (e.g. bumps) and negative (e.g. depressions) defects in the feature's pattern. The number of defects will increase as the technique is taken farther below the normal resolution limit. Since the defects are random, no two fabricated stamps will be the same. Therefore, each stamp will have a section that is fabricated using writing and developing technology that is below its resolution limits, so as to generate an appropriate number of random defects.

Once completed, the silicon master may be used for fabricating a “negative” mold, for fabricating a negative stamp, or used as-is as a stamp (or combined with other silicon masters to form a stamp) for embossing markings into objects or printing markings onto objects.

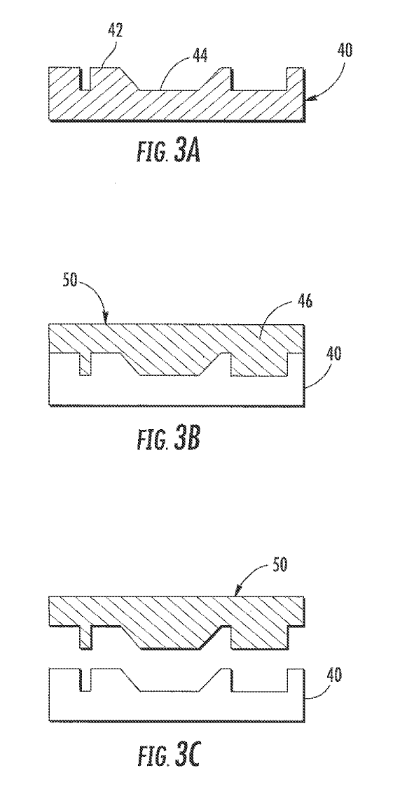

FIGS. 3A-3C illustrate another embodiment of a method for fabricating the stamps of the invention where a silicon master is used for fabricating a negative mold and/or stamp. In this method, a seed layer 44 of electrically conductive material may be deposited onto a feature defining surface 42 of a silicon master 40, as shown in FIG. 3A. The seed layer 44 may be a conductive metal film, such as gold. The seed layer 44 may be deposited using conventional sputtering or evaporating techniques.

Once the conductive seed layer 44 has been deposited, the feature defining surface 42 of the silicon master 40 is plated with a metallic material 46, as shown in FIG. 3B. The plated material forms a negative (relative to the silicon wafer master) electroform mold or stamp 50. In one preferred embodiment, the metallic plating material may be a Ni—Co alloy. Ni—Co alloy is preferred because it has relatively stress free deposition characteristics. The silicon master 40 may be plated according to one embodiment, by configuring the seed layer coated silicon master 40 as a cathode in an electrochemical plating cell (not shown). The metallic material 46 is plated onto the seed layer coated surface 42 of the silicon master 40 until it has a thickness in the range of about 0.5 to about 2 mm.

In FIG. 3C, the electroform negative mold and/or stamp 50 is separated from the positive silicon master 40. Separation may be accomplished by dissolving the silicon master with an aqueous KOH solution. The resulting electroform mold and/or stamp 50 is an exact negative replica of the original positive silicon master mold 40.

One of ordinary skill in the art will of course recognize that other methods may be used for fabricating the negative metal mold and/or stamp 50. Examples of such methods include, without limitation, machining, micromachining, electronic discharge machining, casting.

As mentioned above, the negative electroform 50, in some embodiments, may be used as a stamp. In one embodiment, a plurality of the electroforms 50 may be attached together on a rotating wheel, and used to mark pharmaceutical pills, tablets or the like by embossing and/or printing, at a rate of speed commensurate with pharmaceutical production. In the case of marking by embossing, because the information or a code merely comprises a series of depressions which are not filed with any type of material, there appears no need for any type of FDA approval.

In other embodiments, the negative metal electroform 50 may used as a mold or combined with other electroforms to form a mold, “positive” polymer components with extremely fine features formed therein. In one embodiment, two electroforms may be used as upper and lower molds to fabricate features on opposite faces of a polymer component. In some embodiments, the polymer component may used as a stamp for embossing markings into objects or printing markings onto objects.

In other embodiments, the polymer components may be the objects to be marked. In such embodiments, the identifying markings would be integrated into the body of the polymer object.

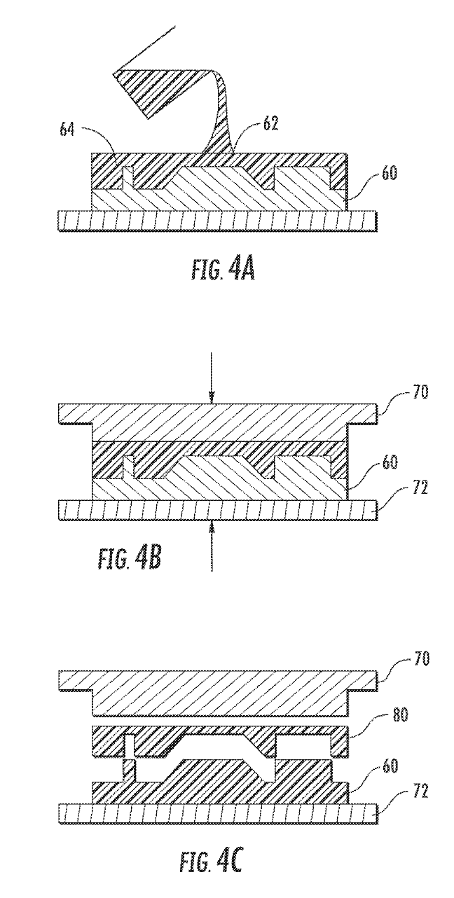

Electroform molds made according to the principles described herein, in some embodiments, may be used for fabricating polymer components, objects or stamps from polymer granules or sheets of polymer, in a conventional compression molding process, as depicted in FIGS. 4A-4C. The polymer granules or sheets, in one embodiment, may be of a polymethylmethacrylate (acrylic) composition. Other types of polymers may be used for molding components, objects or stamps including, without limitation, acrylates, polyurethanes, polyolefins, polyesters, and polyamides, to name a few. In the compression molding process, polymer granules 64 may be poured onto a feature forming surface 62 of a negative electroform mold 60. In an alternative embodiment (not shown), a polymer sheet may be placed between two negative electroform molds.

In FIG. 4B, the electroform mold 60 is then placed between platens 70 and 72 of a heated hydraulic press. The platens 70 and 72 heat and apply pressure to the electroform mold 60 thereby causing the polymer granules 64 to melt and flow into the features of the electroform mold 60. After compressing and heating; a polymer component, object or stamp(s) 80 is separated from the electroform mold 60.

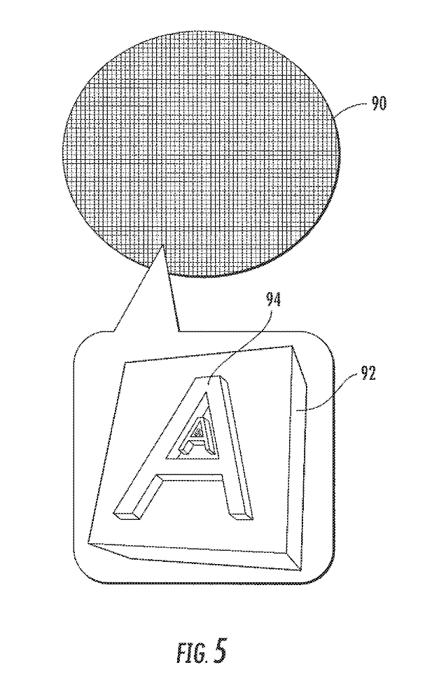

FIG. 5 depicts one embodiment of a polymer wafer 90 including a plurality polymer stamps and/or objects 92 made according to the invention, using the electroform mold process described above. Each stamp and/or object 92 includes a series of hierarchical features 94 (e.g., A-shape and/or code, etc.), the smallest of which includes it own unique identifying traits or defects.

In other embodiments, the negative electroform molds may be used for fabricating polymer components, objects or stamps from polymer granules or sheets of polymer, in other molding processes, including without limitation, resin casting, injection molding, hot embossing or reactive injection molding.

In still other embodiments, silicon master molds fabricated according to the principles of the invention, may be used in place of the electroform molds for fabricating polymer components, objects or stamps from polymer granules or sheets of polymer using plastic molding techniques and methods. Further, silicon master molds and electroform molds may be combined to fabricate polymer components, objects or stamps from polymer granules or sheets of polymer using plastic molding techniques and methods.

In yet other embodiments, the electroform molds of the invention (and other metal molds including the embossing/printing features described above) may be heated to a sufficiently high temperature to thermolyze, burn or char surfaces of the objects molded therein, so as to mark them in accordance with the principles described herein.

Referring again to FIGS. 1A-1D, a single stamp is capable of possessing features on many different size scales that are fabricated at the same time on the stamp. In one preferred embodiment, features with lateral dimension from millimeters to tens of nanometers can be formed on same stamp in conterminous regions at the same time. The advantages of this dimensional hierarchy include:
Increasing difficulty in generating features with size diminution, i.e., the requirements for the etching, exposure and development become more stringent and expensive as the features written become smaller and smaller.
The largest features can be read by nearly anyone with, for example, a magnifying glass, thereby giving some level of comfort to the final consumer who can read at least some of the anticounterfeiting features. The larger features can be read at the highest rate of speed compared to the smaller features of the stamps.
The next smallest features, which in one embodiment may be in the range of 5-50 microns, require an optical microscope for reliable reading of these features. In the application of pharmaceutical tablets and pills, this level of security may be read, for example, at a pharmacy.
The next smallest features, which in one embodiment may be in the range of 0.5-5 microns, require a Scanning Electron Microscope (SEM) to read. This level of security or authentication requires access to equipment for verification that is not available to most individuals.
The features below 100 nm and into the 50 nm range are less readily fabricated and require high quality photolithography or electron beam exposure techniques to fabricate. However at these length scales the lower limits of the writing and developing techniques are beginning to go below the size regime where features can be fabricated with near zero defects. In fact, the fabrication of the smallest features are deliberately carried out using techniques below their typical resolution limits in order to use the naturally generated random defects as means of making each stamp unique. (FIGS. 1A-1D.) These defects can be read with an SEM or, in some embodiments, when the features are below about 50 nm, it becomes convenient and useful to use an Atomic Force Microscope (AFM).
The dimensional hierarchy affects the cost and speed of the reading of the code. The larger the code, the faster it can be read and the less the scanner apparatus will cost. Therefore, the size scale can be judiciously and precisely adjusted in order to determine the ideal degree of protection, speed and cost.

The features or codes of the stamps and the corresponding marked objects, may be read by any method capable of detecting them. Examples of such reading methods include, without limitation, optical methods such as direct imaging and photomicroscopy, scanning electron microscopy, atomic force microscopy and profilometry (mechanical or optical depth measurement). In one embodiment, the surface features may be analyzed with a WYKO optical profiler available from VEECO. An optical profiler is capable of measuring features on a surface within a claimed size regimen from 0.1 nm to 8 mm with a scan rate of 100 μ/sec. The measurements obtained from such an optical profiler may be subsequently analyzed using pattern recognition or like software.

Two separate parts of the stamped object require analysis which are (a) the examination and quantification of the defects and (b) reading of the alphanumeric code with Optical Character Recognition (OCR) software. For example, the image processing modules of Matlab and National Instruments Imaging Package can be used for this analysis. Both of these software packages have pattern recognition algorithms suitable for this analysis. The image processing to read the (LFAT) stamps is envisioned to take place in two steps which are (a) an initial scan to read the alphanumeric characters to verify the digital code and (b) a second slower analysis that will perform image analyses using pattern recognition. The software can be trained to recognize repetitive patters using robust OCR methods which can take place relatively quickly so the Private Key encoding verification can take place very rapidly. If this step fails then the more slow and costly pattern recognition would not be performed. The verification at the pattern recognition stage can take place in a direct pixel-to-pixel comparison of the two images. First, the overall grey scale of the entire image is calculated and the other image to be compared is set to the same overall grayscale intensity. Then a comparison is made not only of the one to one correspondence between the appropriate pixels but of the relative grey levels of the eight nearest neighbor pixels. Pattern recognition of this type has an extremely high accuracy with nearly non-existent false negatives. Image analysis employed Time Delay Integration (TDI) techniques can be employed to analyze moving objects.

In one embodiment, the features or codes of the stamp and the marked object may be read or interpreted by starting at one end of the feature size scale and moving towards the other end of the size scale. For example, the largest feature size may be read with a magnifying glass, the next size level with a high quality optical microscope, the next size level with a scanning electron microscope (SEM) and the final size level with an SEM or atomic force microscope. At the lower ends of the size scales, where the lithography technique is near or past its normal working resolution limits, a series of defects will begin to appear within the smallest features. These defects make each stamp (or mold) and the marking made on the object marked by the stamp (or mold) unique and different from all other stamps (or molds) and impossible to prepare in the same way twice.

Although the invention described herein is suitable for labeling any type of object, one preferred embodiment is for the anticounterfeiting of drugs and pharmaceutical preparations. As described in scheme 1 below, anticounterfeiting of pharmaceuticals is a serious and rapidly growing problem, and there exists a very strong need for a robust solution to protect the drug supply or any valuable object In addition to protecting pharmaceutical products, this technology could label many other objects, without limit, such as spare parts, consumer goods and documents.

Scheme 1: Pharmaceutical Anticounterfeiting: Business Landscape and Statistics
WHO estimates that counterfeit drugs make up 10% of the $400 billion pharmaceutical industry threatening public welfare and manufacturer reputation.
FDA is recommending widespread use of RFID in the pharmaceutical supply chain at the item level by 2007.
In November 2004, several pharmaceutical manufacturers publicly announced RFID initiatives.
Estimated potential market for pharmaceutical brand protection from counterfeiting is about $180 million with an annual growth rate of 10%.
Costs involved in implementing authentication technologies include cost of code generation and labeling, field detection, consumer education.

An ideal method for protecting an object, such as a pharmaceutical tablet or pill, may include as many of the following attributes and features as possible.

Scheme 2: Desirable Features for Pharmaceutical Anticounterfeiting Technology
Provides high level of security.
Impossible to replicate or reverse engineer.
Can be used at any point in supply chain from manufacturing to use by final end user.
Easily changeable and hierarchical security level with the size scale and range of the hierarchy precisely adjusted in order to determine the ideal speed, protection level and cost of the authentication.
Low cost to allow wide spread usage.
Flexible application formats to allow the encoding of any object large or small.
If labeling is to be used at the pill level, the label must either have prior FDA approval or not require FDA approval.
If labeling is to be used at pill level, the technique must be capable of encoding the identifying information and code within a sufficiently small area.
The depth of multiplexing, i.e. the number of resolvable codes that can be measured within the encoded system, must be sufficiently high to prevent replication and reverse engineering.
Is fast enough to not become the slowest step in the pharmaceutical manufacturing process.

Methods for labeling large numbers of biological samples share several common overlapping needs with methods for performing authentication or attribution of a large number of objects. Some methods for labeling very large numbers of biological samples are shown in Table 1. It is clear that many of these methods do not possess the requisite properties especially with respect to the depth of multiplexing the production rate sufficient for the number of pharmaceutical manufactured and especially the need for FDA approval.

TABLE 1
Current Technology for Labeling and
Identifying Large Number of Samples.

| | Multiplexing | Number of Labels in |
|---|---|---|
| Labeling Method | Level Claimed | Product |
| Metallic nanoparticles | 10,000 | 5 different metals |
| Light activated RF | “Unlimited” | Sequence is stored in |
| transmitters | | electronic memory |
| Electroplated metal | “Unlimited” | Six different striping patterns |
| bard codes | | offered |
| Nanowire Superlattice | --Data Not | Superlattices consists of 2 to |
| Structures | available-- | 21 layers of GaAs and GaP |
| Physically etched pits | “Unlimited” | Several sizes of holes |
| Nanocrystals | --Not available-- | --Not available-- |
| Quantum dots | --Not available-- | Six colors, no ratio data |

One common method for labeling objects for tracking purposes is with RFID labels. While very convenient for inventory purposes, the ease of replication or obliteration of the code renders the object less desirable for authentication and anticounterfeiting than many other systems. A comparison of RFID and the LFAT and printing methods described herein is shown in Table 2.

TABLE 2
Comparison of object labeling with RFID and
LFAT/printing methods of the invention.

| | RFID Labeling | LFAT |
|---|---|---|
| Anti-Counterfeiting | Prevents anti-counterfeiting by | Each stamp prepared is |
| | assigning a unique code to each | unique and can never be |
| | individual package and tracking | prepared a second time; thus |
| | what is shipped or received from | reverse engineering is |
| | the manufacturer to the consumer | impossible. |
| | in real time. | |
| Duplicate/Replicate | RFID labels can be readily | |
| | duplicated/replicated by reading | |
| | the data from a label and encoding | |
| | the same data into multiple labels. | |
| Working principle | RFID labels work by reading the | A thin film of a polymer, or |
| | unique data stored in a tag (silicon | other embossable material, is |
| | chip connected to an antenna) | stamped with a unique |
| | using radio frequency | micromachined die that is |
| | transmission. | impossible to replicate. |
| Physical stability of | Device unstable toward very high | Code is light and radiation |
| Code | humidity, high RF fields or other | stable; the stability of the |
| | strong electromagnetic pulses, | code is the same as the |
| | high temperatures. | stability of the polymer film |
| | | and the object being labeled. |
| Ease of Use | RFID label taped or otherwise | Object can be embossed |
| | affixed to object. | directly or an embossed tape |
| | | can be applied to the object. |
| Compatibility with | Presence of metals and liquids in | Since the information is |
| package contents | the package can affect the radio | stored in holes, there can be |
| | frequencies and tag identification. | no material incompatibility |
| | | issues. |
| Physical form of labels | RFID labels/tags are usually | Is prepared in the form of a |
| | attached to objects such as | small piece of polymer film. |
| | standard barcode labels. | These films can be sprayed, |
| | | printed, embedded in the |
| | | packaging paper, plastics, |
| | | glass, pills, etc. |
| Detection method and | Typical detection time ranges | Proven, available, |
| time | from 50 to 200 tags/sec. | inexpensive pattern |
| | | recognition software. |

Table 3 below lists some of the features, advantages and benefits of using the LFAT and printing methods described herein to protect and authenticate pharmaceutical preparations.

TABLE 3
Features, advantages and benefits of the LFAT

| Feature | Advantages of LFAT |
|---|---|
| Label free method | No chemicals added; code is formed from embossed |
| | markings, holes, and/or depressions in the surface of the |
| | object; may be placed on every single object (e.g., |
| | pharmaceutical tablets and pills) without FDA approval. |
| Compatibility with | Compatible with and complimentary to RFID and other |
| authentication technologies | marker technologies. |
| High security level | The methods of writing the code are virtually impossible to |
| | reverse engineer or replicate; generally every stamp has its |
| | own, unique series of randomly occurring manufacturing |
| | “defects.” |
| Each object “labeled” | Using LFAT, each object (e.g., pharmaceutical tablets and |
| | pills) may be labeled with an imprinted code that comprises, |
| | e.g., a public key-private key digital decrypt security or like |
| | scheme, which ensures secure client-to-database |
| | communication. |
| Density of information | With 100 nm × 100 nm feature sizes written into the stamp |
| | there are in some embodiments, 100-500 features/μ², which are |
| | all encoded, thus, packaging information, etc. may be written |
| | onto one object, such as a pharmaceutical tablet or pill. |
| Real world usability | The hierarchical size diminution allows for increasing |
| | difficulty in reading the code and provides a safety check at |
| | every level from manufacturing to PoU consumer. |
| Cost/object labeled | Largest cost associated with labeling pharmaceuticals by this |
| | method would likely be the cost of the data base to track it and |
| | not the encoding itself. |
| Time to label an object | Rapid code changing is possible; an extremely rapid, |
| | continuous process may be used to “label” samples as fast as |
| | they are produced, e.g., by placing the electroformed stamps |
| | onto rollers, polymer or other films could be embossed |
| | continuously at an extremely high rate. |
| Ease of changing encoding | Since the stamps may be made thousands at a time, any |
| with respect to time | number of stamps may be made and rotated into the |
| | authentication schedule at an arbitrary rate; Ni-Co stamps are |
| | magnetic allowing for easy automated manipulation. |
| Robustness of technology | All technologies already well established; no new hardware or |
| for code generation and | chemical material development required. |
| code reading | |
| Very flexible format | Can create features in thin films of any smooth polymer or |
| | other embossable surface. |
| Facile addition of additional | Since the stamps employed are so small, objects can be |
| security layers | labeled with a huge number of different stamps. |

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for identifying, authenticating, and/or attributing information to an object, the method comprising the steps of:
reading a marking formed in or on a surface of an object;
comparing the marking to a marking feature of a stamp or mold that would have been used to legitimately mark the object, the marking feature of the stamp or mold including at least one identifying defect that is unique to the stamp or mold; and
determining whether the marking in or on the surface of the object includes a corresponding feature including the at least one identifying defect to identify, authenticate, and/or attribute information to the object.

2. The method according to claim 1, wherein the at least one identifying defect comprises a manufacturing imperfection which is unique to the manufacture of the stamp.

3. The method according to claim 1, wherein the feature of the marking includes at least one of a code, security feature, number, symbol, sign, digital watermark, arbitrary shape.

4. The method according to claim 1, wherein the feature of the marking defines a dimensional hierarchy of features.

5. The method according to claim 4, wherein the features of the marking vary in size from about 0.5 millimeters to about 50 nanometers.

6. The method according to claim 5, wherein the features of the marking approaching about 50 nanometers include the at least one identifying defect.

7. The method according to claim 1, wherein the object is a pharmaceutical preparation.

8. The method according to claim 7, wherein the pharmaceutical preparation is formed as a tablet.

9. The method according to claim 1, wherein the marking comprises an embossment in the surface of the object.

10. The method according to claim 9, wherein the marking further comprises printed matter printed on the surface of the object.

11. The method according to claim 1, wherein the marking comprises printed matter printed on the surface of the object.

12. The method according to claim 7, wherein the marking includes a private key-public key encryption code.

13. The method according to claim 1, wherein the marking includes a private key-public key encryption code.

14. The method according to claim 1, wherein data corresponding to the marking feature of the stamp or mold is stored in a database.

15. A method for identifying, authenticating, and/or attributing information to an object, the method comprising the steps of:
forming a stamp or mold including a marking feature, the marking feature including at least one identifying defect that is unique to the stamp or mold; and
marking the object with the stamp or mold,
wherein the marking formed in or on the surface of the object can be used to identify, authenticate, and/or attribute information to the object.

16. The method according to claim 15, wherein the at least one identifying defect comprises a manufacturing Imperfection which is unique to the manufacture of the stamp or mold.

17. The method according to claim 15, wherein the marking feature includes at least one of a code, security feature, number, symbol, sign, digital watermark, arbitrary shape.

18. The method according to claim 15, wherein the marking feature defines a dimensional hierarchy of features.

19. The method according to claim 18, wherein the features vary in size from about 0.5 millimeters to about 50 nanometers.

20. The method according to claim 19, wherein the features approaching about 50 nanometers include the at least one identifying defect.

21. The method according to claim 15, wherein the object is a pharmaceutical preparation.

22. The method according to claim 21, wherein the pharmaceutical preparation is formed as a tablet.

23. The method according to claim 15, wherein the marking comprises an embossment in the surface of the object.

24. The method according to claim 23, wherein the marking further comprises printed matter printed on the surface of the object.

25. The method according to claim 15, wherein the marking comprises printed matter printed on the surface of the object.

26. The method according to claim 22, wherein the marking includes a private key-public key encryption code.

27. The method according to claim 15, wherein the marking includes a private key-public key encryption code.

28. The method according to claim 14, wherein the forming step is performed by at least one of microfabrication, electroforming and polymer forming.

29. A device for identifying, authenticating, and/or attributing information to an object, the device comprising:
a surface including a marking feature, the marking feature including at least one identifying defect that is unique to the device,
wherein a marking formed in or on the surface of the object marked with the device is used to identify, authenticate, and/or attribute information to the object.

30. The device according to claim 29, wherein the device comprises a stamp.

31. The device according to claim 29, wherein the device comprises a mold.

32. The device according to claim 29, wherein the device is made from a material selected from the group consisting of semiconductors, ceramics, glasses, and polymers.

33. The method according to claim 1, wherein the reading step is performed using at least one optical method.

34. The method according to claim 33, wherein the at least one optical method is selected from the group consisting of direct imaging and photomicroscopy, scanning electron microscopy, atomic force microscopy and profilometry.
